(19) United States
(12) Patent Application Publication
(10) Pub. No.: US 2026/0133666 A1
(43) Pub. Date: May 14, 2026

(54) EYEDROPPER TOOL WITH FLOATING CARD AND DYNAMIC MENU OPTIONS

(71) Applicant: FIGMA, INC., San Francisco, CA (US)

(72) Inventor: William Joseph SWEENEY, IV, Seattle, WA (US)

(21) Appl. No.: 19/385,046

(22) Filed: Nov. 10, 2025

Related U.S. Application Data
(60) Provisional application No. 63/719,991, filed on Nov. 13, 2024.

(51) Int. Cl. G06F 3/04812; G06F 3/0482; G06F 3/04845

(52) U.S. Cl. CPC G06F 3/04812; G06F 3/0482; G06F 3/04845

(57) ABSTRACT

The present invention sets forth techniques for selecting and transferring content element properties using an eyedropper tool having an associated floating card and a menu including one or more dynamic menu options. The techniques include selecting or otherwise activating the eyedropper tool within an interactive application program. The techniques also include selecting, via the eyedropper tool, a pixel associated with a source content element displayed in the interactive application program and having one or more associated content element properties. The techniques also include displaying, within the eyedropper tool, one or more of the properties for user selection. The techniques further include the user selecting a first property for transferring to a target content element via a first user input modality and, in an instance where the eyedropper tool displays properties, the user selecting a second property for transferring to the target content element via a second user input modality.

### CROSS-REFERENCE TO RELATED APPLICATIONS

This application claims priority benefit of United States Provisional Patent Application titled “EYEDROPPER TOOL WITH FLOATING CARD AND DYNAMIC MENU OPTIONS,” serial number 63/719,991, filed November 13, 2024. The subject matter of this related application is hereby incorporated herein by reference.

### BACKGROUND

### Field of the Various Embodiments

The present invention relates generally to a design application and, more specifically, to a design application including an eyedropper tool having an associated floating card and a menu including one or more dynamic menu options, including all aspects of the related hardware, software, graphical user interfaces, and algorithms associated with implementing the contemplated systems, techniques, functions, and operations set forth herein.

### Description of the Related Art

In the field of graphic design, a creator may wish to select and transfer (copy) one or more properties, such as colors, solid fills, gradient fills, opacity values, images, or videos from one content element included in a virtual canvas to one or more different content elements in the virtual canvas. Further, an individual property may be expressed explicitly, such as a hexadecimal color code, or may be expressed as a variable name. A variable name may be changeably associated with, e.g., one or more different colors, such that when the variable name is associated with a different color, all content elements having the named variable property will update simultaneously to the new color associated with the variable name.

Existing techniques for transferring content element properties may include multiple tools and/or commands, where each tool or command is operable to transfer a single, particular property from one content element to another, or from a designated pixel to a content element. For example, a tool designed to transfer a solid fill color to a target content element may allow a designer to sample a color from a pixel included in a digital canvas, and then apply a solid fill to the target content element, using the sampled color. One drawback to these techniques is that they require multiple different tools to address different types of transferable properties, potentially causing confusion not only as to what function a particular tool performs, but also to the differences between operating the multiple different tools.

Other existing techniques may be operable to transfer one of multiple different types of properties to a target content element, but may be limited to transferring explicitly specified property values, rather than transferring a variable property value. For example, a tool may be able to sample a pixel from, e.g., a red circle to a target content element that includes a square in order to change the color of the square to red, but the tool may not be aware that the circle is red only because the circle was previously assigned a variable name as a color property, and the variable name is currently associated with the color red. One drawback to these techniques is that transferring only explicit property values complicates the use of variable property values associated with, e.g., a default background color or a default opacity level. If a variable property is subsequently assigned a different property value, content elements that include the variable property may automatically change to adopt the new variable value, while content elements that received their property values via explicit value assignment will not change.

As the foregoing illustrates, what is needed in the art are effective techniques for flexibly and selectively transferring object properties between objects associated with a design program or an environment.

### SUMMARY

One embodiment of the present invention sets forth a technique for identifying one or more transferable properties associated with a source content element. The technique includes identifying, based on a first position associated with an eyedropper cursor associated with a user interface, at least one pixel associated with a source content element. The technique also includes, generating, for display, a floating card at a second position based on the first position, wherein the floating card displays a first property of the source content element that is transferable to a target content element via a first user input modality, and displays a second property of the source content element that is transferable to the target content element via a second user input modality different from the first user input modality.

One technical advantage of the disclosed techniques relative to the prior art is that the disclosed techniques are operable to transfer both explicit and variable instance of multiple different content element properties with a single tool, simplifying the transfer of content element properties and facilitating the use and re-use of variable content element properties. The disclosed techniques are also operable to automatically vary one or more tool options presented to a user based on context associated with a source content element and one or more target content elements. The context may include one or more property types associated with either or both of the source content element and the target content element, and may also include one or more allowed and/or prohibited property types associated with the target content element. These technical advantages provide one or more improvements over prior art approaches.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a network computing system to implement an interactive application platform on a user computing device, according to one or more examples.

FIG. 1B illustrates a network computing system to provide an interactive application platform for multiple users in a collaborative environment, according to one or more examples.

FIG. 2 illustrates a user interface (UI) included in an interactive application platform, according to one or more examples.

FIG. 3 is a flow diagram of method steps for transferring one or more properties via an eyedropper tool, according to one or more examples.

### DETAILED DESCRIPTION

In the following description, numerous specific details are set forth to provide a more thorough understanding of various embodiments of the present invention. However, it will be apparent to one of skill in the art that the inventive concepts may be practiced without one or more of these specific details.

### System Overview

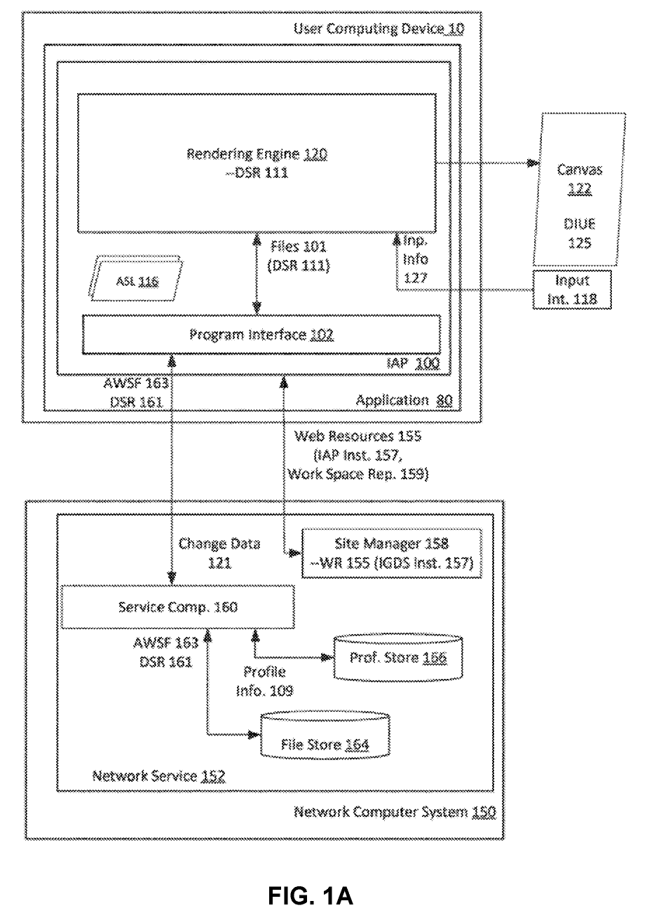

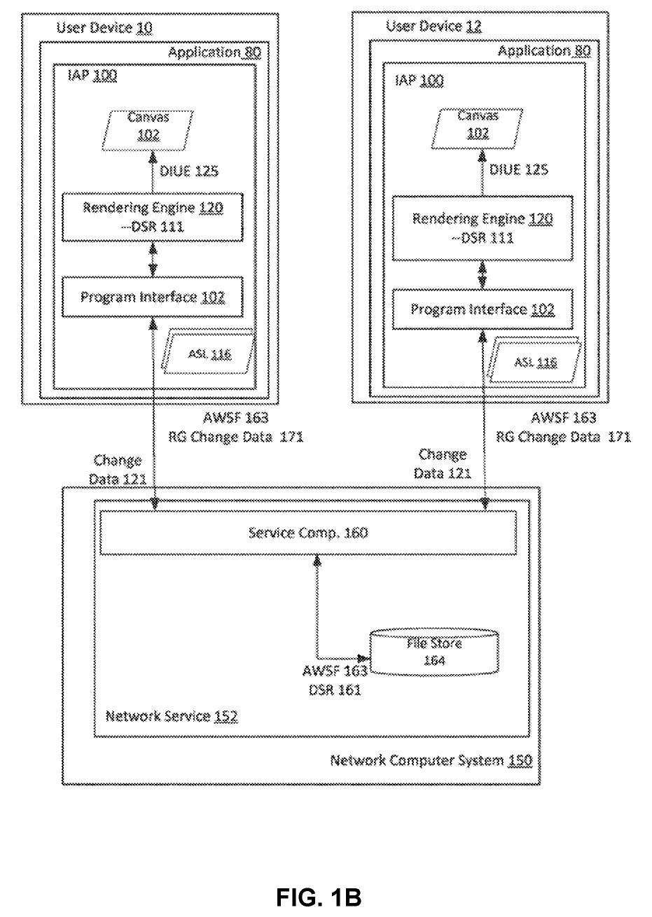

FIG. 1A illustrates a network computing system to implement an interactive application platform on a computing device, according to one or more embodiments. A network computing system such as described with an example of FIG. 1A can be implemented using one or more servers that communicate with user computing devices over one or more networks. In various examples, the network computing system 150 performs operations to enable an interactive application platform (“IAP 100”) that is implemented on user computing devices 10. The IAP 100 can be implemented by the user initiating a session (e.g., user accessing a website) to receive programmatic resources of the IAP 100. A browser component executes the programmatic resources to implement the IAP 100, with functionality to receive user input and to render content that is based on or responsive to user input. As described, the IAP 100 is implemented to enable the user to create various types of content, such as interactive graphic designs, art, whiteboard content, program code renderings, large or small language model prompts, multimedia content, presentations, and/or textual content. As further described, the IAP 100 can include logic (“ASL 116”) for implementing one or more application services, where each application service is implemented through the IAP 100 to provide a corresponding set of functionality and user experience. The IAP 100 also implements the application services to share some resources, such as the canvas, workspace file or library of design elements. Further, the IAP 100 enables multiple application services to be used during a given online session and/or with respect to a particular application service.

According to examples, a user of computing device 10 operates web-based application 80 to access a network location, such as a cloud computing endpoint, where programmatic resources are retrieved and executed to implement the IAP 100. The web-based application 80 can execute scripts, code and/or other logic (the “programmatic components”) to implement functionality of the IAP 100. In examples, the web-based application 80 can correspond to a commercially available browser, such as GOOGLE CHROME (developed by GOOGLE, INC.), SAFARI (developed by APPLE, INC.), and INTERNET EXPLORER (developed by the MICROSOFT CORPORATION). In such examples, the processes of the IAP 100 can be implemented as scripts and/or other embedded code which web-based application 80 downloads from a network location. For example, the web-based application 80 can execute code that is embedded within a webpage to implement processes of the IAP 100. The web-based application 80 can also execute the scripts to retrieve other scripts and programmatic resources (e.g., libraries) from the network location and/or other local or remote locations. By way of example, the web-based application 80 may execute JAVASCRIPT embedded in an HTML resource (e.g., webpage structured in accordance with HTML 5.0 or other versions, as provided under standards published by W3C or WHATWG consortiums). In some examples, the rendering engine 120 may utilize graphics processing unit (GPU) accelerated logic, such as provided through WebGL (Web Graphics Library) programs which execute Graphics Library Shader Language (GLSL) programs that execute on GPUs.

The IAP 100 can be implemented as part of a network service, where web-based application 80 communicates with one or more remote computers (e.g., server used for a network service) to execute processes of the IAP 100. The web-based application 80 retrieves some or all of the programmatic resources for implementing the IAP 100 from a network location. The web-based application 80 may also access various types of data sets in providing the IAP 100. The data sets can correspond to files and design libraries (e.g., predesigned design elements), which can be stored remotely (e.g., on a server, in association with an account) or locally. In examples, the network computing system 150 provides a shared design library which the user computing device 10 can use with any of the application services provided through the IAP 100. In this way, the user may initiate a session to implement the IAP 100 for purpose of creating or editing the workspace file, as rendered on the canvas 122, in accordance with one of multiple collaborative application services of the IAP 100.

In examples, the IAP 100 includes a program interface 102, an input interface 118 and a rendering engine 120. The program interface 102 can include one or more processes, which execute to access and retrieve programmatic resources from local and/or remote sources. In an implementation, the program interface 102 can generate, for example, a canvas 122, using programmatic resources which are associated with web-based application 80 (e.g., HTML 5.0 canvas). As an addition or variation, the program interface 102 can trigger or otherwise cause the canvas 122 to be generated using programmatic resources and data sets (e.g., canvas parameters) which are retrieved from local (e.g., memory) or remote sources (e.g., from network service).

The program interface 102 may also retrieve programmatic resources that include an application framework for use with canvas 122. The application framework can include data sets that define or configure, for example, a set of interactive graphic tools that integrate with the canvas 122 and that comprise the input interface 118, to enable the user to provide input to generate or update content rendered on the canvas 122.

According to some examples, the input interface 118 can be implemented as a functional layer that is integrated with the canvas 122 to detect and interpret user input. The input interface 118 can, for example, process a user's interaction with an input mechanism (e.g., pointer device, keyboard) of the user computing device, to detect, for example, cursor positioning/movement with respect to the canvas 122, hover input (e.g., pre-selection input), selection input (e.g., clicks or double clicks), shortcuts (e.g., key board inputs), hand gestures (e.g., point or pinch) and other inputs. In processing a user's interaction with a pointer device, the input interface 118 can use a reference of the canvas 122 to identify a screen location of a user's cursor as the user moves or otherwise interacts with the pointer device. Additionally, the input interface 118 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In such examples, the input interface 118 can interpret, for example, a series of inputs as a design tool selection (e.g., shape selection based on location of input), as well as inputs to define attributes (e.g., dimensions) of a selected shape. In other examples, the input interface 118 can interpret a continuous input (corresponding to a continuous movement of the user's pointer device) as selecting a tool (e.g., shape too) and canvas location where an output of the selected tool is to appear.

In some examples, the IAP 100 includes application service logic 116 to enable multiple application services to be utilized during a given user session, where each application service provides the user with a particular functionality and/or user experience. As described by some examples, each application service is implemented by the IAP 100 utilizing a corresponding application service logic 116 to configure the input interface 118, rendering engine 120 and/or other components of the IAP 100 to provide the functionality and user experience of the corresponding application service. In this way, the IAP 100 enables the user to operate multiple application services during one online session. Further, the different application services can share resources, including programmatic resources of the IAP 100, such as canvas 122. In this way, each application service can contribute content to and/or utilize features and content provided with the canvas 122 during a given session. Still further, the application services can be implemented as alternative modalities of IAP 100, such that the user can toggle between modes, where each mode provides a particular functionality and user experience. In examples, each application service can utilize a common workspace file associated with the user. By default, a computing device that opens the workspace file can utilize a default application service to access and/or update that workspace file. The user may also switch the mode of operation of the IAP 100 to utilize a different application service to access, use and/or update the workspace file.

The network computing system 150 can include a site manager 158 to manage a website where a set of web resources 155 (e.g., web page) are made available for the web-based application 80 of user computing devices 10. The web resources 155 can include instructions, such as scripts or other logic (“IAP instructions 157”), which are executable by browsers or web components of user computing devices. The web resources 155 can also include (i) resources that are to be shared as between application services, provided to the user computing devices in connection with the user computing devices utilizing either of the application services, and (ii) application specific resources, which execute on the user computing devices for a particular one of the available application services. The web resources 155 can also include a design library of design elements that is partially or fully shared as between the application services. The library of design elements can enable the user to select predetermined design elements for use on the canvas 122 in connection with the user utilizing either of the application services.

In some variations, once the computing device 10 accesses and downloads the web resources 155, web-based application 80 executes the IAP instructions 157 to implement functionality as described with examples. For example, the IAP instructions 157 can be executed by web-based application 80 to initiate the program interface 102 on the user computing device 10. The initiation of the program interface 102 may coincide with the establishment of, for example, a web-socket connection between the program interface 102 and a service component 160 of the network computing system 150.

In some examples, the web resources 155 includes logic which web-based application 80 executes to initiate one or more processes of a program interface 102, causing the IAP 100 to retrieve additional programmatic resources and data sets for implementing functionality as described by examples. The web resources 155 can, for example, embed logic (e.g., JAVASCRIPT code), including GPU accelerated logic, in an HTLM page for download by computing devices of users. The program interface 102 can be triggered to retrieve additional programmatic resources and data sets from, for example, the network service 152, and/or from local resources of the computing device 10, in order to implement each of the multiple application services of the IAP 100. For example, some of the components of the IAP 100 can be implemented through webpages that can be downloaded onto the computing device 10 after authentication is performed, and/or once the user performs additional actions (e.g., download one or more pages of the workspace associated with the account identifier). Accordingly, in examples as described, the network computing system 150 can communicate the IAP instructions 157 to the computing device 10 through a combination of network communications, including through downloading activity of web-based application 80, where the IAP instructions 157 are received and executed by web-based application 80.

The computing device 10 can use web-based application 80 to access a website of the network service 152 to download the webpage or web resource. Upon accessing the website, web-based application 80 can automatically (e.g., through saved credentials) or through manual input, communicate an account identifier to the service component 160. In some examples, web-based application 80 can also communicate one or more additional identifiers that correlate to a user identifier.

Additionally, in some examples, the service component 160 can use the user or account identifier of the user identifier to retrieve profile information 109 from a user profile store 166. As an addition or variation, profile information 109 for the user can be determined and stored locally on the user's computing device 10.

The service component 160 can also retrieve the files of an active workspace (“active workspace files 163”) that are linked to the user account or identifier from a file store 164. The profile store 166 can also identify the workspace that is identified with the account and/or user, and the file store 164 can store the data sets that comprise the workspace. The data sets stored with the file store 164 can include, for example, the pages of a workspace and one or more data structure representations 161 for the design under edit that is renderable from the respective active workspace files.

As an addition or variation, each file can be associated with metadata that identifies the application service that was used to create the particular file. In some examples, the metadata identifies the default application service for viewing, utilizing or otherwise updating the application service.

Additionally, in examples, the service component 160 provides a representation 159 of the workspace associated with the user to the web-based application 80, where the representation identifies, for example, individual files associated with the user and/or user account. The workspace representation 159 can also identify a set of files, where each file includes one or multiple pages, and each page including objects that are part of a design interface.

On the user device 10, the user can view the workspace representation through web-based application 80, and the user can elect to open a file of the workspace through web-based application 80. In examples, upon the user electing to open one of the active workspace files 163, web-based application 80 initiates the canvas 122. For example, the IAP 100 can initiate an HTML 5.0 canvas as a component of web-based application 80, and the rendering engine 120 can access one or more data structures representations 111 of content rendered on the canvas 122.

The IAP 100 utilizes application service logic 116 to implement multiple modes of operation, where each mode corresponds to an application service. As described, the application service logic 116 associated with each service application can include instructions and data for configuring the components of IAP 100 to include functionality and features of the corresponding application service. Accordingly, the application service logic 116 can, for example, configure the application framework and/or input interface 118 to differ in form, functionality and/or configuration as between the alternative modes of the IAP 100. Additionally, the type of actions and interactions which the user can perform to register input can vary based on the modes of operation. Still further, the different modes of operation can include different input or user-interface features for the user to select and use for inclusion on the canvas 122. By way of example, when the IAP 100 is operating in a mode for whiteboarding service application, the program interface 102 can provide input features to enable a user to select a design element that is in the form of a “sticky note,” while in an alternative mode for an interactive graphic design service application, the “sticky note feature” is not available. However, in the alternative mode, the user may be able to select anyone of numerous possible shapes or previously designed objects which the user can write textual messages in for display on the canvas 122.

Additionally, the application service logic 116 can configure the operation of the rendering engine 120, such that the functionality and behavior of the rendering engine 120 differs as between different application services. In this way, the rendering engine 120 functions to provide alternative behaviors for different modes of operation, coinciding with the particular service application that is active. By way of example, the configuration of the rendering engine 120 can affect the appearance of the canvas 122, the appearance (e.g., visual attributes) of rendered content elements on the canvas 122, the behavior or representation of user interaction (e.g., whether the user cursor or pointer device is represented on the canvas 122), the type or specific content that is rendered, the physic engine that is used by the rendering engine to represent dynamic events (e.g., the object being moved), what user operations can be performed (e.g., whether select objects can be resized), and the like.

Additionally, each of the application services can utilize a shared library of content elements (e.g., graphic design element), as well as core functionality that enables design elements to be shared and updated between the different application services that are available through the platform. Additionally, the workspace file created and edited through use of one application service can be utilized with the other application service. Moreover, the transition between application services can be seamless—for example, the user computing device 10 can open a workspace file using the first application service (e.g., interactive graphic design application service for UIX design) then seamlessly switch to using the second application service (e.g., whiteboarding application service) with the same file, without closing the workspace file. In such example, each application service enables the user to update the workspace file even while the workspace file is in use by other computing devices (e.g., such as in a collaborative environment). In such examples, the user can mode switch the IAP 100 to switch which application service is in use, with each application service utilizing the workspace file.

FIG. 1B illustrates a network computing system to provide an interactive application platform for multiple users in a collaborative environment, according to one or more examples. In an example of FIG. 1B, a collaborative network platform is implemented by the network computing system 150, which communicates with multiple user computing devices 10, 12 over one or more networks (e.g., World Wide Web) to implement the IAP 100 on each computing device. While FIG. 1B illustrates an example in which two users utilize the collaborative network platform, examples as described allow for the network computing system 150 to enable collaboration on design interfaces amongst a larger group of users.

In an example of FIG. 1B, multiple computing devices 10, 12 initiate a collaborative session, where each computing device 10, 12 implements a version or instance of the IAP 100. In various embodiments, multiple computing devices 10, 12 may include a desktop computer, a laptop computer, a smart phone, a personal digital assistant (PDA), tablet computer, or any other type of computing device configured to receive input, process data, optionally display images, and is suitable for practicing one or more embodiments. Multiple computing devices 10 and 12 may further include a head-mounted display (HMD), such as the APPLE VISION PRO (developed by APPLE, INC). The network computing system 150 communicates with each computing device 10, 12 over one or more networks (e.g., World Wide Web) to enable the computing devices to collaborate. In particular, the network computing system 150 implements the IAP 100 on individual computing devices 10, 12, and enables each computing device 10, 12 to create, update or interact with a shared canvas 122.

With respect to FIG. 1B, the user computing devices 10, 12 can be assumed as being operated by users that are associated with a common account, with each user computing device 10, 12 implementing a corresponding IAP 100 to access the same workspace during respective sessions that overlap in time with one another. Accordingly, each of the user computing devices 10 and 12 may access the same set of active workspace files 163 at the same time, with the respective program interface 102 of the IAP 100 on each user computing device 10 and 12 operating to establish a corresponding communication channel (e.g., web socket connection) with the service component 160.

The service component 160 can communicate a copy of the active workspace files 163 to each user computing device 10, 12, such that the computing devices 10, 12 render an active workspace file 163 at the same time. In some examples, an active workspace file 163 can be associated with a default application service, and each computing device 10, 12 can open the active workspace file 163 using the associated (or default) application service. Still further, in other variations, pages or portions of the workspace file can be associated with different application services.

Each of the computing devices 10, 12 can maintain a local data structure representation 111 of the content rendered on the canvas 122, which may be based at least in part on the selected workspace file. The service component 160 can also maintain a network-side data structure representation 161 which can initially be obtained from the files of the active workspace 163 and maintained through communication with each of the computing devices 10, 12 during a collaborative session. In this way, the network-side data structure can coincide with the local data structure representations 111 on each of the computing devices 10, 12.

In some examples, the user of the computing devices 10, 12 can switch the operational mode of the IAP 100 so as to view and update the workspace using a non-default application service. Thus, in some variations, the active workspace file can be updated by the users utilizing either of the application services.

By way of example, during a collaboration session, users can view and edit a shared workspace file using, for example, either a graphic design application service or a whiteboarding application service. The network computing system 150 can detect changes made by users that utilize either of the graphic design application service or whiteboarding application service, and the network computing system 150 can propagate detected changes on any one of the user computing devices to the other user computing devices. Further, individual users that participate in the collaborative environment can download and open the workspace file using a default application service (e.g., whiteboarding application service), then switch to the other design application service without closing the workspace file. Accordingly, in some examples, the IAP 100 is implemented to provide application services that utilize shared resources (e.g., workspace, design library). In some examples, a shared workspace can include components or segments (such as pages or other logically distinct segments of a workspace) that are associated with different application services. Thus, for example, one page (or other segment) of a workspace file can be associated with a graphic design application service by default, while another page may be associated with a whiteboarding application service. The default designation of the application service can correlate to the mode of operation that the IAP 100 utilizes to enable the corresponding user to access the page. Still further, while some examples provide that the IAP 100 can switch modes to enable the user to view and/or edit a page or other segment of a workspace using a non-default application service, in variations, the IAP can be implemented in a manner that precludes pages or segments of the workspace from, depending on implementation, being viewed (e.g., read access) or updated (e.g., write access) through an application service other than the default application service, while other pages or segments of the workspace file can be accessed through either of the application services. Thus, in some variations, the IAP 100 can be implemented to restrict portions of a shared resource (e.g., page or segment of a workspace file) from being accessible through an application service other than the default application service. Still further, in other examples, the IAP 100 can be implemented to selectively limit (e.g., based on settings, such as specified by admin user) the ability of certain users (e.g., users of a particular class or role) from using an application service other than the default application service to either view or update a shared resource (e.g., workspace, library of content elements, etc.) or portion thereof of the shared resource. By way of illustration, in the case of a library of design elements, all users associated with an account my access the library to select content elements from the design library for rendering on a collaborative medium, using either of the application services. However, only users of a specific role (e.g., “graphic design user”) may be permitted to create a new or updated design element to be stored with the shared design library. Further, in some variations, the ability of such users to create or update the content element may also be selectively limited to allow for changes which are made through one of the application services (e.g., the default application service) but not the other. In this way, the IAP 100 can configure the manner in which application services are utilized with shared resources, as described in examples and other variations.

In some examples, the web resources 155 include or provide a given workspace file that includes a library of design elements which may be made available to one or multiple application services. Still further, in examples, the design elements library can be updated by users using either of the application services provided through the IAP 100. Moreover, in some variations, changes made by individual users to design elements of the library can be propagated to (i) instances of the library provided to other user computing devices (e.g., such as users of a collaborative session or users who subsequently access the library), and/or (ii) the content and/or interfaces rendered on the canvas 122 of other users which participate in different collaborative sessions and utilize the particular design element.

To illustrate the latter variation, a user of a collaborative session can update a design element of the library that is used in connection with an active workspace file of a collaborative session. Further, in variations, the user can update the library using either of the application services. If the design element is in use on the design interface that is shared during the collaborative session, the change to the design element as stored with the design library can be automatically detected by the network computing system 150, and the change can be propagated to (i) each instance of the library that is downloaded to the user computers, (ii) the design element as rendered on the canvas 122 of the individual users of the collaborative session, and (iii) the design element as rendered on the canvas 122 of other users who are not participating in the collaborative session.

The network computing system 150 and each computing device 10, 12 that is participating in the collaborative session can maintain a data representation of the shared content. In some examples, the shared content can reflect content that is generated from, for example, user interactions, such as cursor elements. Content such as depiction of cursor elements may be shared for one application service (e.g., whiteboarding), but not the other application service.

In such examples, when a user operating a computing device moves the cursor, the user's computing device can update the local data representation of the shared content to reflect the change in the user's cursor. Each computing devices 10, 12 can generate change data that reflects changes to the local data representation 111 maintained on the respective computing device 10, 12, as a result of changes the user makes to the shared content, where those changes include cursor movements and actions of the user. Each computing device 10, 12 can stream change data to the network computing system 150, which in turn updates the network's representation 161 of the shared content. The network computing system 150 can reconcile change data received from the various computing devices to update the network's representation of the shared content. The network computing system 150 then streams an updated representation of the shared content to each of the computing devices that participated in the collaborative session.

The network computing system 150 can continuously synchronize the shared content and/or active workspace files 163 on each of the user computing devices. In particular, changes made by users to shared content and/or a selected active workspace file 163 on one computing device 10, 12 may be immediately (i) reflected in the respective data structure representation 161 of the workspace file, and (ii) rendered on the other user computing device 10, 12. By way of example, the user of computing device 10 can make changes to shared content that affects a corresponding respective workspace file. Alternatively, the user of the computing device 10 can interact with the shared canvas 122 in a manner where the content is changed, without any change being needed to the workspace file. For example, the user can generate ephemeral text content (e.g., cursor text) that is linked to the cursor element, representing the user's pointer device and interaction with the canvas 122. In examples, the local data structure representation 111 is updated to reflect the update to the workspace file and/or shared content. From the computing device 10, the program interface 102 of the IAP 100 can stream change data 121, reflecting the change of the user input, to the service component 160. The service component 160 processes the change data 121 of the user computing device. The service component 160 can use the change data 121 to make a corresponding change to the network-side data structure representation 161. The service component 160 can also stream remotely generated change data 171 (which in the example provided, corresponds or reflects change data 121 received from the user device 10) to the computing device 12, to cause the corresponding IAP 100 to update the workspace file as rendered on the other device. The computing device 12 may also use the remotely generated change data 171 to update with the local data structure representation 111 of that computing device 12. The program interface 102 of the computing device 12 can receive the update from the network computing system 150, and the rendering engine 120 can update the workspace file and the respective local copy of 111 of the computing device 12.

The reverse process can also be implemented to update the data structure representations 161 of the network computing system 150 using change data 121 communicated from the second computing device 12 (e.g., corresponding to the user of the second computing device updating the shared content and/or workspace file as rendered on the second computing device 12). In turn, the network computing system 150 can stream remotely generated change data 171 (which in the example provided, corresponds or reflects change data 121 received from the user device 12) to update the local data structure representation 111 of the workspace file on the first computing device 10. In this way, the workspace file of the first computing device 10 can be updated as a response to the user of the second computing device 12 providing user input to change the workspace file.

To facilitate the synchronization of the data structure representations 111 on the computing devices 10, 12, the network computing system 150 may implement a stream connector to merge the data streams which are exchanged between the first computing device 10 and the network computing system 150, and between the second computing device 12 and the network computing system 150. In some implementations, the stream connector can be implemented to enable each computing device 10, 12 to make changes to the network-side data representation 161, without added data replication that may otherwise be required to process the streams from each device separately.

Additionally, over time, one or both of the computing devices 10, 12 may become out-of-sync with the server-side data representation 161. In such cases, the respective computing device 10, 12 can redownload the active workspace files 163, to restart the maintenance of the data structure representation 111 of the workspace file that is rendered and edited on that device.

### Eyedropper Tool

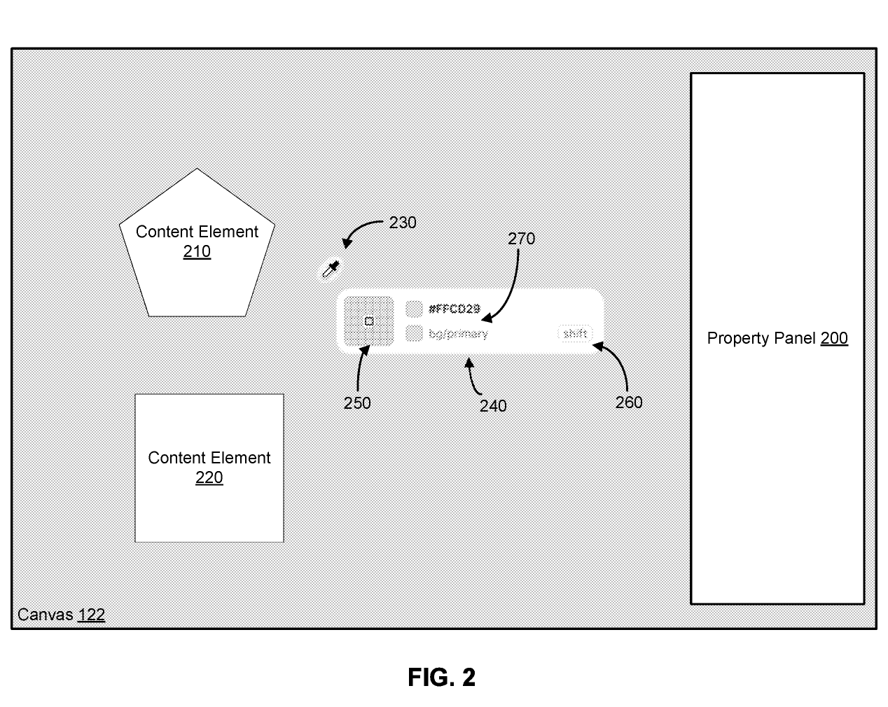

FIG. 2 illustrates a user interface (UI) included in an interactive application platform, according to one or more embodiments. The user interface includes, without limitation, canvas 122, property panel 200, content element 210, content element 220, eyedropper cursor 230, floating card 240, loupe 250, modifier indicator 260, and property display regions 270.

Property panel 200 includes a graphical interface displayed in association with canvas 122, where the graphical interface includes one or more user-selectable fields, such as text boxes, radio buttons, tabs, and one or more icons associated with tools included in interactive application platform (IAP) 100. Property panel 200 may include one or more property sub-panels, such as a color sub-panel or a style sub-panel. The color sub-panel and style sub-panel may display color and style information, respectively, associated with one or more pixels and/or content elements included in canvas 122. Color information may include a color code or color variable name associated with a pixel, and style information may include a specified font, font weight, font size, and/or other stylistic options, such as gradients or images. A user may select and execute a tool, such as an eyedropper tool, via selection of one of the icons included in property panel 200 and associated with tools included in the IAP 100.

In some examples, a user may initiate the eyedropper tool by selecting, e.g., via a mouse click, an icon associated with the eyedropper tool and located in one or more sub-panels included in property panel 200. The user may also initiate the eyedropper tool via a different user input modality, such as pressing a single key or a combination of keys included in a keyboard.

Each of content element 210 and content element 220 includes a visual representation of an object displayed in canvas 122. An object may include, without limitation, a region of pixels filled with a color or pattern, an image, a video clip, or textual content. Each of content element 210 and content element 220 may also include one or more properties, such as a color property or a style property associated with content element 210 or content element 220. In various examples, a color property or style property may include a designation of a specific color or style, respectively. Alternatively, a color property or style property may include a reference to a variable, where the variable is associated with a specific color or style. More than one content element may be linked to a single variable, such that any change in the color or style associated with the variable is propagated to all of the linked content elements.

Eyedropper cursor 230 includes a visual indication of at least one location within canvas 122 where eyedropper cursor 230 is positioned via a user input device, such as a mouse, touchpad, hand gesture, or touchscreen. As a user manipulates a user input device, the position of eyedropper cursor 230 within canvas 122 changes based on the user manipulation. In various embodiments, eyedropper cursor 230 is associated at any given time with one or more pixels included in canvas 122, where the one or more pixels correspond to the position of eyedropper cursor 230.

A user may select a pixel (or a group of pixels) associated with eyedropper cursor 230 and sample one or more properties associated with the pixel. The one or more properties may include a color property or style property associated with the pixel. The user may select the pixel and sample the associated property via an input on the user input device, such as a mouse click, a touchpad gesture, or a screen tap. IAP 100 may transfer the sampled property to a designated target content element. For example, a user may designate content element 220 as a target content element. The user may then sample a property associated with a pixel included in content element 210, transferring the sampled property to content element 220.

In some embodiments, a pixel location associated with eyedropper cursor 230 may not be located within canvas 122. For example, a user may sample, via eyedropper cursor 230 and one or more user inputs, a property associated with a pixel included in a different environment, such as a different application program, a computer desktop background, an image, or a frame of a video sequence. A pixel location associated with eyedropper cursor 230 may also be associated with an object or other visual element included in an augmented reality/virtual reality (AR/VR) environment and viewed by the user via a head-mounted device (HMD) included in user computing devices 10, 12. For example, a user may sample, via the HMD and one or more input devices, a property associated with an object located within the user’s environment and outside of the boundaries of canvas 122 and IAP 100.

Floating card 240 includes a visual depiction of a fixed arrangement of elements associated with the eyedropper tool. These elements include, without limitation, loupe 250, property display regions 270, and modifier indicator 260. In some examples, the position of floating card 240 within canvas 122 is determined based on the location of eyedropper cursor 230 within canvas 122. Floating card 240 may be displayed at a location determined by a predetermined offset relative to the position of eyedropper cursor 230. In various examples, the offset is expressed in pixels. For example, a top-left corner included in floating card 240 may be displayed a fixed number of pixels to the right of and a fixed number of pixels below eyedropper cursor 230. In some examples, IAP 100 may dynamically adjust the offset such that floating card 240 does not obscure a particular portion of canvas 122, such as property panel 200. IAP 100 may also adjust the offset such that no portion of floating card 240 extends outside of canvas 122.

Floating card 240 may include an associated opacity value, where the opacity value determines the visibility of pixels included in canvas 122 that would appear to a user to be behind floating card 240. The opacity value may include one of a range of values, where the range of values may indicate complete transparency, complete opacity, and varying levels of partial transparency.

Loupe 250 includes a visual indication of a pixel included in canvas 122 and associated with the position of eyedropper cursor 230. In some examples, the visual indication may include a bold or otherwise distinctive outline around a depiction of the pixel included in loupe 250. Loupe 250 also includes a visual depiction of one or more pixels located within a region of pixels surrounding the pixel associated with the position of eyedropper cursor 230. Loupe 250 provides a magnified view of the pixel associated with the position of eyedropper cursor 230 and of the surrounding pixels. Consequently, the visual appearance of loupe 250 may dynamically update as the user repositions eyedropper cursor 230. Loupe 250 may include horizontal and vertical grid lines that divide loupe 250 into cells, where each cell may display one or more associated pixels included in canvas 122. In various embodiments, loupe 250 may include dynamic grid lines. In these embodiments, the dynamic grid lines may change color based on the color(s) displayed in loupe 250. For example, a dynamic grid line that is displayed over a darker portion of loupe 250 may be displayed in a lighter color to increase contrast and improve visibility of the grid lines. Similarly, a dynamic grid line that is displayed over a lighter portion of loupe 250 may be displayed in a darker color.

Each of property display regions 270 included in floating card 240 may include an indication of a property included in the pixel associated with the position of eyedropper cursor 230. As an example, each of the property display regions included in property display regions 270 as shown in FIG. 2 represents a color property included in the pixel associated with the position of eyedropper cursor 230. A color property may include a hexadecimal code, e.g., #FFCD29, associated with the color of the pixel associated with the position of eyedropper cursor 230. A color property may also include a variable name, e.g., “bg/primary” associated with the color included in the pixel associated with the position of eyedropper cursor 230.

In various embodiments, if a selected source content element has no style applied, but has a variable applied, and the target content element can accept a variable, a property display region included in property display regions 270 may show a variable name, even if the variable color does not match the rendered hex color associated with the pixel of canvas 122 associated with eyedropper cursor 230. For example, other properties applied to the pixel may take precedence over or otherwise interfere with the variable color.

If a selected source content element has no style applied, but has multiple variables applied, and the target content element can accept a variable, a property display region included in property display regions 270 may show a variable that is closest in color value to the rendered hex color associated with the pixel of canvas 122 associated with eyedropper cursor 230. If a variable name or other text is too long to display inside floating card 240, the text may be truncated to fit into the available width of floating card 240.

Canvas 122 may include a content element that exhibits anti-aliasing, such as a thin diagonal line having a pixel width of, e.g., one pixel. An anti-aliased content element having an associated hex color value may include pixels having hex color values that differ slightly from the hex color value associated with the content element. For example, IAP 100 may shade pixels adjacent to a thin diagonal line to reduce a jagged appearance of the line resulting from IAP 100 displaying a diagonal line on canvas 122 comprising horizontal rows and vertical columns of pixels. IAP 100 may shade the adjacent pixels using a color that is slightly darker or lighter than the hex color value associated with the content element. In various embodiments, IAP 100 may modify the operation of eyedropper cursor 230 such that if the position of eyedropper cursor 230 corresponds to an anti-aliased pixel included in a content element, display regions 270 may display color values and/or variable names associated with the content element, rather than color values and/or variable names associated with the anti-aliased pixel located at the position of eyedropper cursor 230.

In various embodiments, IAP 100 may restrict eyedropper cursor 230 from sampling colors and/or variables associated with user interface (UI) elements included in IAP 100, such as property panel 200 or a tool bar displaying icons representing selectable tools. In these embodiments, IAP 100 may inhibit the display of floating card 240 when a location associated with eyedropper cursor 230 corresponds to a UI element location. Additionally, IAP 500 may cause eyedropper cursor 230 to change to a different cursor style as a visual indication that the current pixel location may not be sampled.

In various embodiments where IAP 100 is operable to create new variables and/or styles associated with a content element, IAP 100 may inhibit sampling via eyedropper cursor 230 during the creation of a new variable or a new style, according to one or more hierarchical rules. For example, IAP 100 may inhibit the sampling of styles when creating a new variable or a new style, based on hierarchical rules prohibiting either styles or variables from containing a style. Similarly, IAP 500 may allow the sampling of variables when creating a new variable or a new style, based on a hierarchical rule specifying that both styles and variables are permitted to contain a style.

In various embodiments, IAP 100 is operable to sample properties associated with a pixel corresponding to a location of eyedropper cursor 230, even in instances where source and/or content elements have not been selected. IAP 100 may also store the sampled properties in e.g., a clipboard and/or other repository for later retrieval. For example, in the absence of selected source or target content elements, selecting a pixel location with eyedropper cursor 230 and performing an input action such as clicking a mouse button may cause IAP 100 to record one or more properties associated with the selected pixel to a clipboard.

In instances where a source content element associated with a location of eyedropper cursor 230 includes neither variables nor styles, IAP 100 may cause property display regions 270 to display a selectable option to create a variable or a style to associate with the selected target content element(s). In various embodiments, IAP 100 may determine the selectable option based on whether the target content element may accept a variable, a style, or either a variable or a style. For example, if a selected target content element is operable to accept either a variable or a style, IAP 100 may default to causing display regions 270 to display a selectable option to create a variable. After a user creates, e.g., a color variable, the newly created color variable is applied to the target content element.

In an instance where a first or default property displayed in property display regions 270 includes a color property, IAP 100 may be operable to cycle through multiple representations of the color property upon specified user input. For example, pressing a designated key on a keyboard may cause a first or default property displayed in property display regions 270 to switch from one color scheme representation of the color to a different color scheme representation, such as switching from one to another of a hex, RGB, CMYK, HSL (Hue / Saturation / Lightness), or HSB (Hue / Saturation / Brightness) color scheme representation. In various embodiments, IAP 100 may designate a switching order for the various color schemes, where the designated order may also cause the displayed color scheme to wrap around from a last scheme included in the order to a first scheme included in the order when the designated key is pressed.

In various embodiments, IAP 100 may temporarily hide the grid lines in loupe 250 in response to a designated user input, such as holding down a specified key. Alternatively or additionally, IAP may persistently hide the grid lines based on an individual user’s preferences.

In various embodiments, IAP 100 may include additional logic rules that govern the display of options in property display regions 270 based on allowable/available properties associated with a selected source content element and one or more target content elements. For example, IAP 100 may cause the display of multiple options each directed to transferring one of one or more properties including uniform fill patterns, gradient fill patterns, opacity values, image fills, or video fills.

A user may transfer a property displayed in one of property display regions 270 to a designated target content element, such as content element 220. The user may select which of the displayed properties to transfer based on an input modality associated with a user input. For example, clicking a mouse button may select one of the displayed properties for transfer, while pressing a keyboard key while clicking a mouse button may select a different displayed property for transfer. In some examples, a property display region may include an indication of a user input modality associated with the property display region. For example, a property that may be transferred via a mouse click alone may be displayed in a bolded or otherwise distinctive font, as illustrated by the hexadecimal code #FFCD29 included in property display regions 270. Continuing the example, a property that may be transferred via a combination of a mouse click and a keyboard input may include an associated modifier indicator 260 specifying the keyboard input, such as the visual depiction of a keyboard “SHIFT” key included in modifier indicator 260.

In some embodiments, a user may transfer a property from a content element associated with one application program to a content element included in a different application program. In these embodiments, the eyedropper tool may be implemented as a standalone widget or tool operable to interact with multiple different application programs. The eyedropper tool may dynamically adjust one or more property display regions included in property display regions 270 based on, for example, an application from which the eyedropper tool is sampling a property or a different application to which the eyedropper tool is transferring the property.

Although property display regions 270 are depicted as including two property display regions, this is not intended to be limiting, and property display regions 270 may include any number of property display regions. In some examples, a property display region may include a menu icon indicating that an associated user input modality will display a menu including one or more additional property display regions and/or one or more selectable options or functions. A property display region may include a textual description of, e.g., a currently selected tool included in IAP 100. In various embodiments, a designated key, key combination, or other user input may cause a property display region to cycle through each of the options available for display in the property display region.

In some examples, one or more property display regions included in property display regions 270 may automatically update based on a dynamically determined context. The context may be based on one or more of the properties associated with a sampled pixel or the source content element, one or more of the properties associated with a designated target content element, and/or one or more properties associated with a content creation environment, e.g., a textual editor, a programming environment, an AR/VR environment, etc. For example, given a designated target content element that is operable to receive a transferred color property including a specific hexadecimal color code, property display regions 270 may include a property display region including the hexadecimal color code associated with in the pixel associated with the position of eyedropper cursor 230. Given a designated target content element that is not operable to receive a transferred color property including a variable name, property display regions 270 may omit a variable name associated with the pixel corresponding to the position of eyedropper cursor 230.

In some examples, IAP 100 may dynamically update one or more fields included in the color sub-panel and/or style sub-panel included in property panel 200 based on properties associated with the pixel associated with the position of eyedropper cursor 230. For example, IAP 100 may dynamically update a hexadecimal code included in a color sub-panel field as the position of eyedropper cursor 230 changes over time. Similarly, IAP 100 may also synchronize a field type associated with a field included in the color sub-panel of property panel 200 based on one or more property display regions included in property display regions 270. For example, a user may choose to display a color code included in a property display region as Red/Green/Blue/Alpha (RGBA) values rather than a hexadecimal color code. IAP 100 may synchronize a color display field included in the color sub-panel such that the color display field displays colors as RGBA values, mirroring the user’s choice to display RGBA color values in the property display region.

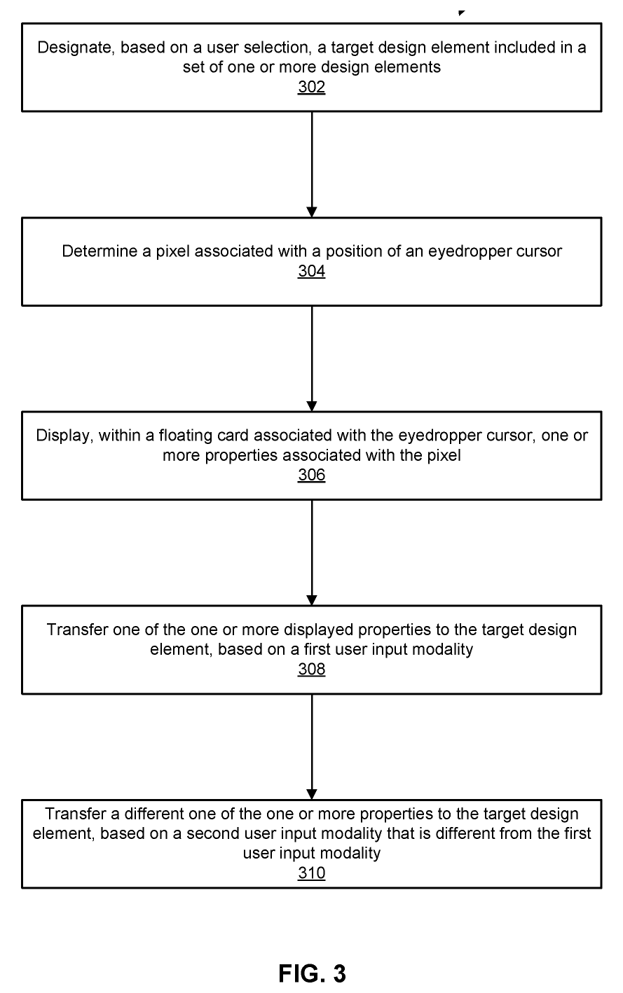

FIG. 3 is a flow diagram of method steps for transferring one or more properties via an eyedropper tool, according to one or more examples. Although the method steps are described in conjunction with the systems of FIGS. 1A and 1B and the user interface of FIG. 2, persons skilled in the art will understand that any system configured to perform the method steps in any order falls within the scope of the present disclosure.

As shown, in step 302 of method 300, interactive application platform (IAP) 100 designates a target content element, such as one of content element 210 or content element 220. IAP 100 may designate the target content element based on a user selection, such as the user clicking on a content element via a mouse or pressing one or more keys included in a computer keyboard.

In step 304, IAP 100 identifies at least one pixel associated with a position of eyedropper cursor 230. In various examples, the position of eyedropper cursor 230 may be located within canvas 122. In other examples, the position of eyedropper cursor 230 may be located outside of canvas 122 and within, e.g., a different application program, a web browser, a computer desktop background, or an augmented reality/virtual reality (AR/VR) environment. A pixel location associated with eyedropper cursor 230 may also be associated with an object or other visual element included in the augmented reality/virtual reality (AR/VR) environment and viewed by the user via a head-mounted device (HMD) included in user computing devices 10, 12. For example, a user may sample, via the HMD and one or more input devices, a property associated with an object located within the user’s environment and outside of the boundaries of canvas 122 and IAP 100.

In step 306, IAP 100 displays floating card 240 associated with eyedropper cursor 230. IAP 100 calculates a location of floating card 240 based on a location associated with the eyedropper cursor and a predetermined offset between eyedropper cursor 230 and floating card 240. For example, IAP 100 may locate floating card 240 a predetermined number of pixels below and to the right of eyedropper cursor 230, and dynamically update the location associated with floating card 240 based on a change in the location of eyedropper cursor 230. Floating card 240 includes one or more property display regions 270, where each property display region displays a property included in the pixel associated with the location of eyedropper cursor 230. Properties may include, e.g., color properties or style properties.

In step 308, IAP 100 transfers one of the one or more displayed properties included in property display regions 270 to the target content element, based on a first user input modality. For example, IAP 100 may transfer a particular one of the one or more displayed properties to the target content element based on a mouse click received from a user via a user input device. A property included in one of property display regions 270 may include an indication of an associated user input modality. For example, a property displayed in a bolded or otherwise distinctive font may indicate that the property may be transferred to the target content element via a single left-click of a mouse.

In step 310, IAP 100 transfers a different one of the one or more displayed properties included in property display regions 270 to the designated target content element, based on a second user input modality that is different from the first user input modality. For example, IAP 100 may transfer a different property included in the one or more displayed properties to the target content element via a combination of a mouse click and one or more keyboard inputs. The different property displayed in property display regions 270 may include an associated modifier indicator 260 specifying a keyboard input that, when combined with a mouse click, will cause IAP 100 to transfer the different property to the target content element.

In sum, the disclosed techniques include an interactive design program having an eyedropper tool. The eyedropper tool includes an associated floating card displaying one or more dynamic menu options. A user of the interactive design program may use the eyedropper tool to transfer one or more content element properties, such as colors, fills, and/or gradients associated with a source content element to one or more target content elements. The user may select a content element property via one or more dynamic menu options included in the floating card. Each dynamic menu option may be selectable using a different input modality, such as clicking a mouse or clicking a mouse while holding down a specified key on a keyboard. The dynamic menu options may include explicit properties, such as hex color codes associated with a background color. Additionally or alternatively, the dynamic menu options may include variable properties expressed as variable names. For example, a variable property may include a variable name “bg/primary” representing a primary or default background color. When the value of a variable property is changed, any content element that includes the variable property will automatically update based on the new variable property value. The dynamic menu options may also be context-aware, such that the interactive design program selects one or more dynamic options based on prohibited and/or allowable property types associated with the one or more target content elements.

In operation, a user of an interactive application program (IAP), such as an interactive design program, may select or otherwise activate an eyedropper tool by, e.g., typing a keyboard shortcut associated with the eyedropper tool, or by selecting an icon included in a property panel and associated with the eyedropper tool. When the eyedropper tool is active, the IAP may replace a cursor included in the IAP with an eyedropper cursor.

A user may reposition the eyedropper cursor within a canvas included in the IAP using mouse, trackball, touchscreen, and/or similar input device. In various embodiments, the position of the eyedropper corresponds to a location of a pixel or group of pixels included in the canvas. The eyedropper tool may include a floating card that is displayed at a fixed location relative to the eyedropper cursor, such that the floating card follows the eyedropper cursor as the eyedropper cursor is repositioned within the canvas. The floating card may include a loupe that displays a close-up rendering of the pixel corresponding to the eyedropper cursor location, along with a collection of pixels surrounding the corresponding pixel shown in, e.g., a square or other rectangular grid of cells.

The floating card may also include one or more display regions, where each display region may include an indication of a property included in the pixel associated with the position of the eyedropper cursor. For example, if the pixel associated with the position of the eyedropper cursor is located within a content element, such as an object displayed on the canvas, the pixel may include a property associated with the object, such as a color. A property value may be expressed as an explicit value, such as a hex color code. Alternatively or additionally, a property may be expressed as a variable name, such as “bg/primary” representing a primary or default background color.

In an instance where each of multiple display regions in the floating card includes a different property, a user may select any one of the different properties using a different one of multiple input modalities, and transfer the selected property to one or more designated target content elements. For example, a user may select a first property by clicking a mouse button while the eyedropper tool is displaying the property. Alternatively, the user may select a second property by clicking a mouse button while holding down a modifier key on a keyboard, such as a SHIFT or CONTROL key. In various embodiments, a display region may include an indicator next to a displayed property specifying a modifier key associated with the property.

For a source content element associated with the eyedropper cursor, the IAP may include logic that determines which options to display in the display regions of the eyedropper tool, depending on the properties included in the source content element and/or one or more prohibited or allowed property types included in the one or more target content elements. For example, if the source content element includes a style, such as an explicitly defined color, fill, or gradient, and the target content element can accept a style, then the display region may show the style associated with the source content element. If a source content element includes neither a style property nor a variable property, and the target content element can accept a variable property but not a style property, the display region may present an option to create a variable property and transfer the created variable property to the target content element(s).

One technical advantage of the disclosed techniques relative to the prior art is that the disclosed techniques are operable to transfer both explicit and variable instance of multiple different content element properties with a single tool, simplifying the transfer of content element properties and facilitating the use and re-use of variable content element properties. The disclosed techniques are also operable to automatically vary one or more tool options presented to a user based on context associated with a source content element and one or more target content elements. The context may include one or more property types associated with either or both of the source content element and the target content element, and may also include one or more allowed and/or prohibited property types associated with the target content element. These technical advantages provide one or more improvements over prior art approaches.

1. In some embodiments, a computer-implemented method comprises designating a target content element within a user interface as a target for property transfer, identifying, based on a first position associated with an eyedropper cursor associated with the user interface, at least one pixel associated with a source content element, generating a floating card at a second position based on the first position and a predetermined offset between the eyedropper cursor and the floating card, wherein the floating card displays a first property of the source content element that is transferable to the target content element via a first user input modality, and displays a second property of the source content element that is transferable to the target content element via a second user input modality different from the first user input modality, and transferring, in response to receiving an input of the second user input modality, the second property displayed in the floating card to the target content element.

2. The computer-implemented method of clause 1, wherein the first user input modality comprises at least a click event associated with a first user input device and the second user input modality comprises at least a button press associated with a second user input device.

3. The computer-implemented method of clauses 1 or 2, wherein the floating card moves as the eyedropper cursor moves within the user interface and remains at a relative location from the eyedropper cursor.

4. The computer-implemented method of any of clauses 1-3, wherein the first property comprises a color of the source content element, and the second property comprises a variable linked to a color or a style of one or more content elements including the source content element.

5. The computer-implemented method of any of clauses 1-4, further comprising determining that the floating card is to display the first property or the second property based on context information associated with the source content element, the target content element, the user interface, or a type of content being generated.

6. The computer-implemented method of any of clauses 1-5, wherein the context information includes a type of property that is transferable to the target content element.

7. The computer-implemented method of any of clauses 1-6, wherein a modification associated with the first property or the second property is propagated to a property panel displayed in association with the user interface.

8. The computer-implemented method of any of clauses 1-7, wherein the second property is displayed in the floating card within a nested menu that is navigable via the second user input modality.

9. In some embodiments, one or more non-transitory computer readable media comprising a set of instructions that, when executed by one or more computing devices, cause the one or more computing devices to perform the steps of designating a target content element within a user interface as a target for property transfer, identifying, based on a first position associated with an eyedropper cursor associated with the user interface, at least one pixel associated with a source content element, generating a floating card at a second position based on the first position and a predetermined offset between the eyedropper cursor and the floating card, wherein the floating card displays a first property of the source content element that is transferable to the target content element via a first user input modality, and displays a second property of the source content element that is transferable to the target content element via a second user input modality different from the first user input modality, and transferring, in response to receiving an input of the second user input modality, the second property displayed in the floating card to the target content element.

10. The one or more non-transitory computer readable media of clause 9, wherein the first user input modality comprises at least a click event associated with a first user input device and the second user input modality comprises at least a button press associated with a second user input device.

11. The one or more non-transitory computer readable media of clauses 9 or 10, wherein the floating card moves as the eyedropper cursor moves within the user interface and remains at a relative location from the eyedropper cursor.

12. The one or more non-transitory computer readable media of any of clauses 9-11, wherein the first property comprises a color of the source content element, and the second property comprises a variable linked to a color or a style of one or more content elements including the source content element.

13. The one or more non-transitory computer readable media of any of clauses 9-12, wherein the steps further comprise determining that the floating card is to display the first property or the second property based on context information associated with the source content element, the target content element, the user interface, or a type of content being generated.

14. The one or more non-transitory computer readable media of any of clauses 9-13, wherein the context information includes a type of property that is transferable to the target content element.

15. The one or more non-transitory computer readable media of any of clauses 9-14, wherein a modification associated with the first property or the second property is propagated to a property panel displayed in association with the user interface.

16. The one or more non-transitory computer readable media of any of clauses 9-15, wherein the second property is displayed in the floating card within a nested menu that is navigable via the second user input modality.

17. In some embodiments, a computer system comprises one or more memories storing a set of instructions, and one or more computing devices that execute the set of instructions to designate a target content element within a user interface as a target for property transfer, identify, based on a first position associated with an eyedropper cursor associated with the user interface, at least one pixel associated with a source content element, generate a floating card at a second position based on the first position and a predetermined offset between the eyedropper cursor and the floating card, wherein the floating card displays a first property of the source content element that is transferable to the target content element via a first user input modality, and displays a second property of the source content element that is transferable to the target content element via a second user input modality different from the first user input modality, and transfer, in response to receiving an input of the second user input modality, the second property displayed in the floating card to the target content element.

18. The computer system of clause 17, wherein the second property is displayed in the floating card within a nested menu that is navigable via the second user input modality.

19. The computer system of clauses 17 or 18, wherein the first property comprises a color of the source content element, and the second property comprises a variable linked to a color or a style of one or more content elements including the source content element.

20. The computer system of any of clauses 17-19, wherein a modification associated with the first property or the second property is propagated to a property panel displayed in association with the user interface.

Any and all combinations of any of the claim elements recited in any of the claims and/or any elements described in this application, in any fashion, fall within the contemplated scope of the invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described examples.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to example embodiments of the present disclosure, other and further embodiments of the disclosure may be devised without departing from the basic scope thereof, and the scope thereof is determined by the claims that follow.

What is claimed is:

1. A computer-implemented method comprising:
designating a target content element within a user interface as a target for property transfer;
identifying, based on a first position associated with an eyedropper cursor associated with the user interface, at least one pixel associated with a source content element;
generating a floating card at a second position based on the first position and a predetermined offset between the eyedropper cursor and the floating card, wherein the floating card displays a first property of the source content element that is transferable to the target content element via a first user input modality, and displays a second property of the source content element that is transferable to the target content element via a second user input modality different from the first user input modality; and
transferring, in response to receiving an input of the second user input modality, the second property displayed in the floating card to the target content element.

2. The computer-implemented method of claim 1, wherein the first user input modality comprises at least a click event associated with a first user input device and the second user input modality comprises at least a button press associated with a second user input device.

3. The computer-implemented method of claim 1, wherein the floating card moves as the eyedropper cursor moves within the user interface and remains at a relative location from the eyedropper cursor.

4. The computer-implemented method of claim 1, wherein the first property comprises a color of the source content element, and the second property comprises a variable linked to a color or a style of one or more content elements including the source content element.

5. The computer-implemented method of claim 1, further comprising determining that the floating card is to display the first property or the second property based on context information associated with the source content element, the target content element, the user interface, or a type of content being generated.

6. The computer-implemented method of claim 5, wherein the context information includes a type of property that is transferable to the target content element.

7. The computer-implemented method of claim 1, wherein a modification associated with the first property or the second property is propagated to a property panel displayed in association with the user interface.

8. The computer-implemented method of claim 1, wherein the second property is displayed in the floating card within a nested menu that is navigable via the second user input modality.

9. One or more non-transitory computer readable media comprising a set of instructions that, when executed by one or more computing devices, cause the one or more computing devices to perform the steps of:
designating a target content element within a user interface as a target for property transfer;
identifying, based on a first position associated with an eyedropper cursor associated with the user interface, at least one pixel associated with a source content element;
generating a floating card at a second position based on the first position and a predetermined offset between the eyedropper cursor and the floating card, wherein the floating card displays a first property of the source content element that is transferable to the target content element via a first user input modality, and displays a second property of the source content element that is transferable to the target content element via a second user input modality different from the first user input modality; and
transferring, in response to receiving an input of the second user input modality, the second property displayed in the floating card to the target content element.

10. The one or more non-transitory computer readable media of claim 9, wherein the first user input modality comprises at least a click event associated with a first user input device and the second user input modality comprises at least a button press associated with a second user input device.

11. The one or more non-transitory computer readable media of claim 9, wherein the floating card moves as the eyedropper cursor moves within the user interface and remains at a relative location from the eyedropper cursor.

12. The one or more non-transitory computer readable media of claim 9, wherein the first property comprises a color of the source content element, and the second property comprises a variable linked to a color or a style of one or more content elements including the source content element.

13. The one or more non-transitory computer readable media of claim 9, wherein the steps further comprise determining that the floating card is to display the first property or the second property based on context information associated with the source content element, the target content element, the user interface, or a type of content being generated.

14. The one or more non-transitory computer readable media of claim 13, wherein the context information includes a type of property that is transferable to the target content element.

15. The one or more non-transitory computer readable media of claim 9, wherein a modification associated with the first property or the second property is propagated to a property panel displayed in association with the user interface.

16. The one or more non-transitory computer readable media of claim 9, wherein the second property is displayed in the floating card within a nested menu that is navigable via the second user input modality.

17. A computer system, comprising:
one or more memories storing a set of instructions; and
one or more computing devices that execute the set of instructions to:
designate a target content element within a user interface as a target for property transfer;
identify, based on a first position associated with an eyedropper cursor associated with the user interface, at least one pixel associated with a source content element;
generate a floating card at a second position based on the first position and a predetermined offset between the eyedropper cursor and the floating card, wherein the floating card displays a first property of the source content element that is transferable to the target content element via a first user input modality, and displays a second property of the source content element that is transferable to the target content element via a second user input modality different from the first user input modality; and
transfer, in response to receiving an input of the second user input modality, the second property displayed in the floating card to the target content element.

18. The computer system of claim 17, wherein the second property is displayed in the floating card within a nested menu that is navigable via the second user input modality.

19. The computer system of claim 17, wherein the first property comprises a color of the source content element, and the second property comprises a variable linked to a color or a style of one or more content elements including the source content element.

20. The computer system of claim 17, wherein a modification associated with the first property or the second property is propagated to a property panel displayed in association with the user interface.
